(19) United States
(12) Patent Application Publication
(10) Pub. No.: US 2006/0220443 A1
(43) Pub. Date: Oct. 5, 2006

(54) Axle hub cover

(76) Inventor: Wayne Olson, Suffern, NY (US)

Correspondence Address: Michael E. Zall, Two Yorkshire Drive, Suffern, NY, 10901, US

(21) Appl. No.: 11/092,051

(22) Filed: Mar. 30, 2005

(51) Int. Cl. B60B 7/16

(52) U.S. Cl. 301/108.1

(57) ABSTRACT

A hub cover for securement to a drive axle hub after removal of a drive axle therefrom, the hub surrounding an axle opening from which the drive axle has been removed and for retaining oil therein. The axle cover is a plate having an exterior surface and an interior mounting surface, the plate being of a size sufficient to cover the hub and the axle opening. A mounting means is provided for mounting the plate on the hub. An oil access means is associated with the plate for selectively adding oil to the axle opening and retaining the oil therein. When the plate is mounted to the hub the interior mounting surface and hub form a sealing surface that surrounds the axle opening to prevent leakage of oil from the opening.

### BACKGROUND OF THE INVENTION

1. Field of the Invention

This invention relates to the field of axle hub covers for use while towing a vehicle after the drive axle is removed for safe towing.

2. Description of the Related Art

When towing large trucks and buses it is often necessary to disengage the drivetrain of the vehicle to prevent damage to the transmission while the vehicle is being towed. Generally, there are two methods used for disengaging the drivetrain. One method involves removing the drive shaft. Another method involves removing the drive axles, typically one or both drive axles. When the drive axle is removed, it is highly desirable to use axle covers, and in particular the axle covers of this invention.

Referring to FIG. 1 herein, in order to remove the drive axle 26, the vehicle is raised, i.e., “jacked up,” until the tires (not shown) attached to the drive axle 26 are off of the ground. The tires are retained on brake drum assembly 16 by wheel retaining studs 18 therefore. The axle hub retaining nuts 40 on retaining studs 24 that retain the drive axle flange 32 and drive axle hub gasket 36 on the axle housing 22 are then removed and the axle 26 is pulled out of the axle housing 22. The axle hub 22 and bearings therein (not shown in FIG. 1) are now exposed and if towed in such a condition the oil drains out of the bearing housing and road dust and dirt gets into the axle housing 22 and bearings. This can cause burnt bearings, melted seals and/or sintered hubs.

Various devices and methods have been used in an attempt to prevent the loss of oil and protect the hub and bearings. Usually, a piece of cardboard is placed over the hub to keep the dirt out and help retain the oil in the axle hub. This solution to the problem is not effective. This solution does not retain the oil in the bearings and the bearing and/or axle hub assembly can be severely damaged as a result of being towed without the proper lubrication, especially on long-distance tows.

Another solution that has been attempted is to make plywood axle covers. These are somewhat better at sealing the hub, but there is still substantial leakage of oil and there is no way of adding oil to the hub and bearings to maintain the proper level prior to and during towing.

Thus there is a need for an improved axle cover that can be mounted on an axle hub that can prevent the entry of road dirt into the hub and bearings and prevent the leakage of oil therefrom during towing and that enables oil to be introduced to the hub and bearing housing prior to and during the towing operation.

Some examples of prior art include the following references:

U.S. Pat. No. 5,024,488 to Lindhuber et al describes a hub cover assembly for non-driving, oil retaining, vehicular wheel ends of the type utilized on highway trucks. The hub consists of a synthetic plastic hub cover, separate fastener members, and a gasket. The hub improves the efficiency in the production line mounting of hub covers to vehicular wheel ends. The hub includes a plurality of apertures for mounting the hub and an oil plug for accommodating an initial charge of oil. The hub cover requires a gasket and is used in the production line mounting of hub covers to wheel ends, i.e., the reference does not teach or suggest its use during towing.

Other U.S. Patents of interest are:

U.S. Pat. No. 6,309,027 to Smith describes a removable decorative wheel cover for covering central wheel portions on wheels for various types of vehicles. The hubs are made of a thin rigid and pliable perforated plastic disc and can have a valve stem opening.

U.S. Pat. No. 6,485,106 to Hermansen, et al. describes an adjustable wheel rim protective mask for protecting the wheel rim from over spray of tire dressing.

U.S. Pat. No. 6,354,670 to Cheng describes a clamping assembly for a wheel axle.

U.S. Pat. No. 6,030,050 to Ichikawa, et al. describes a wheel cover which can be mounted on wheels having the same standardized diameter irrespective of types of the wheels.

U.S. Pat. No. 5,992,942 to Passoth, et al. describes a protective covering for air-permeable light-alloy rims of motor vehicles to protect the disc brake lying behind against salt corrosion during overseas transport for long periods. The covering is a rigid, round, closed molded sheet which reaches over the outer side of the light-alloy rim, covering its surface area, as far as over the rim flange. The covering is clasped centrally on the vehicle wheel by fastening studs molded into the molded sheet to the wheel bolts/nuts or the correspondingly countersunk depressions. The fastening studs are adapted in terms of number, position and shape to the wheel bolts or nuts themselves or to the countersunk depressions provided for this purpose in the rims. The covering is formed from a rigid sheet of a thermoplastic polymer.

U.S. Pat. No. 5,435,630 to Tucher describes a tire rim and hubcap protector for protecting the surface of the wheel rim of an automobile against damage by toxic cleaning solutions used to clean the surrounding tire. The shield is temporarily attached to the rim with a grasping device held by the person cleaning the tire.

U.S. Pat. No. 5,366,279 to Polka describes a decorative oil hub cover for truck wheels.

U.S. Pat. No. 5,263,770 to Goudey describes a truck wheel cover.

U.S. Pat. No. 5,039,172 to Krieger describes a protective cover for installation to a vehicle wheel to prevent dirt, dust or foreign substances from entering through openings in the wheel into brake assemblies carried by the wheel. The cover is a relatively thin, flexible, dirt impervious planar sheet of plastic film having a circular outer periphery sized to substantially cover the wheel. The cover is held in place by a pressure sensitive adhesive.

U.S. Pat. No. 3,331,638 to Fruth describes a hubcap with a fill plug hub cap for use on wheel and axle assemblies of trucks and trailers.

U.S. Pat. No. 2003/0137187 to Williams describes a circular paper or cardboard mask for a vehicle wheel for use while cleaning the wheel. Attachment of the mask to the vehicle wheel is accomplished with permanent magnets embedded in the disk or by an annular band of pressure sensitive adhesive on one face of the disk.

D387725 to Cochran et al and D378364 to Clifton show designs for a protective wheel cover.

PCT Publication WO 9519906 A1 to Ratibe describes a protective wheel cover

### OBJECTS AND SUMMARY OF INVENTION

It is an object of this invention to provide an axle hub cover for a vehicle that will protect the axle hub bearing from dirt while the vehicle is being towed without its drive axle.

It is yet another object of this invention to provide an axle hub cover for a vehicle that prevents the leakage of oil from the axle hub bearing and permits the intermittent selective addition of oil to the bearing housing before and during the towing operation.

It is a further object of this invention to provide a gasketless axle hub cover for a vehicle that prevents the leakage of oil from the axle hub bearing while the vehicle is being towed without its drive axle.

It is also an object of the invention to provide an easy to install axle hub cover for use while the vehicle is being towed without its drive axle that can be easily mounted on an axle hub, that can prevent the entry of road dirt into the hub and bearings, prevent the leakage of oil therefrom during towing, and that enables oil to be introduced to the hub and bearing housing prior to and intermittently during the towing operation.

All of the foregoing objects as well as others are achieved by the hub cover of this invention. The hub cover is adapted for securement to a drive axle hub after removal of a drive axle therefrom, the hub surrounding an axle opening from which the drive axle has been removed and for retaining oil therein. The axle cover comprises a plate having an exterior surface and an interior mounting surface. The plate is of a size sufficient to cover the hub and the axle opening. A mounting means is provided for mounting the plate on the hub. An oil access means associated with the plate is provided for selectively adding oil to the axle opening and retaining the oil therein. When the plate is mounted to the hub the interior mounting surface and hub form a sealing surface that surrounds the axle opening to prevent leakage of oil from the opening.

In the preferred embodiment, the hub cover is adapted for securement to a drive axle hub after removal of the drive axle. The hub has a plurality of retaining studs axially mounted to the hub for mounting a flange of the drive axle thereto. The axle cover comprises a substantially cylindrical plate having an exterior surface and an interior mounting surface, the plate being of a sufficient diameter to cover the hub and the axle opening. A plurality of mounting holes is formed in the outer periphery of the plate, the mounting holes being of a sufficient number and juxtaposition to mate with the retaining studs. The plate further includes an oil access hole that passes through the plate into the axle opening and a removable plug mounted in the oil access hole that is removably accessible from the exterior surface. When the retaining studs pass through the mounting holes and the cover is secured to the hub, the interior surface and hub form a sealing surface that surrounds the axle opening to prevent leakage of oil from the opening.

### BRIEF DESCRIPTION OF THE DRAWINGS

For a more complete understanding of the present invention, reference may be had to the following description of the exemplary preferred embodiments of the present invention considered in connection with the accompanying drawings, of which:

FIG. 1 is an exploded perspective view of a drive axle assembly for which the hub cover of this invention is adapted to be used.

FIG. 2 is an exploded perspective view showing a first embodiment of the axle hub cover of this invention in use on the drive axle assembly after the drive axle is removed;

FIG. 3 is a plan view of the axle cover depicted in FIG. 2;

FIG. 4 is a cross-sectional view of the axle hub cover depicted in FIG. 3 taken along line 4-4 thereof;

FIG. 5 is a plan view of a second embodiment of the axle hub cover of this invention;

FIG. 6 is a partial plan view of a third embodiment of the axle hub cover installed on a hub cover;

FIG. 7 is a partial cross-sectional view of the drive axle hub assembly having one of the embodiments of the axle hub cover of FIGS. 2-6 installed thereon;

FIG. 8 is a plan view of a fourth embodiment of a dished axle hub cover of this invention;

FIG. 9 is a cross-sectional view of the axle hub cover depicted in FIG. 8 taken along line 9-9 thereof; and

FIG. 10 is a partial cross-sectional view of the drive axle hub assembly having the fourth embodiment of the axle hub cover of FIGS. 8-9 installed thereon.

In all of the Figures, like numbers indicate the identical elements.

### DETAILED DESCRIPTION OF THE INVENTION

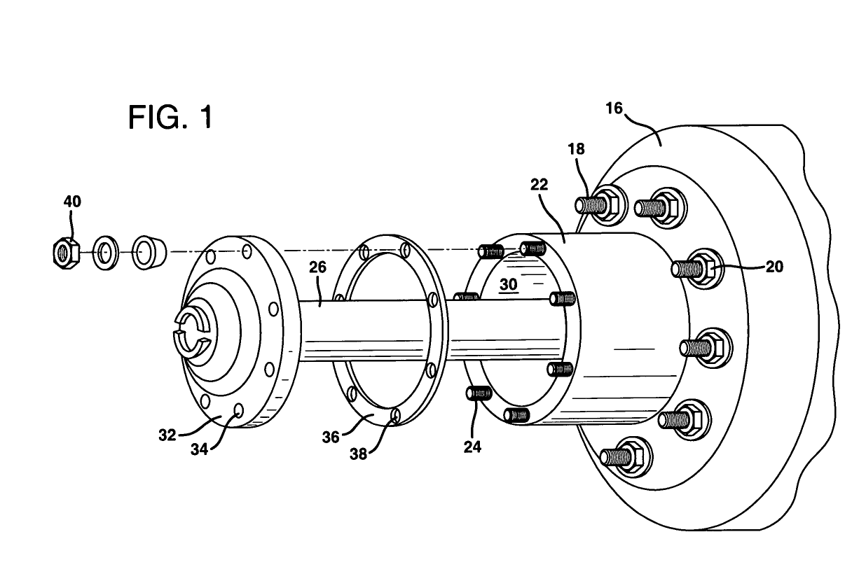

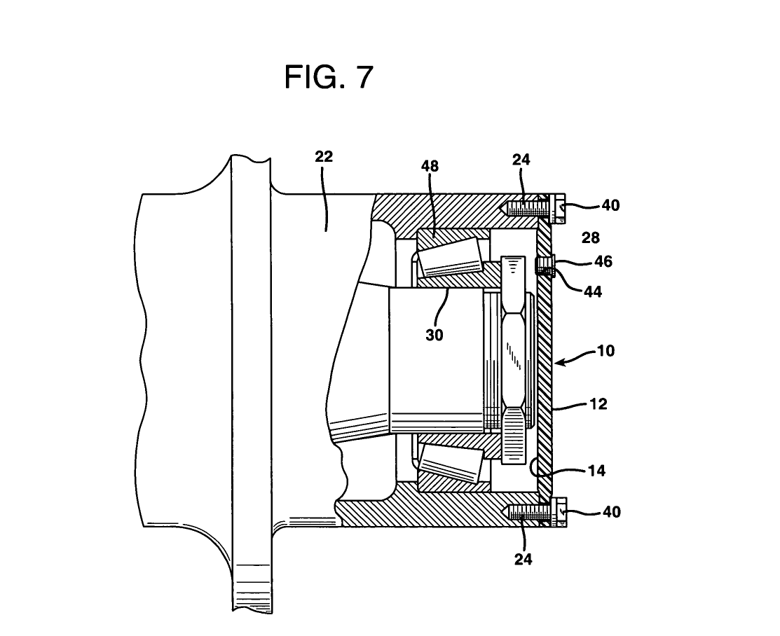

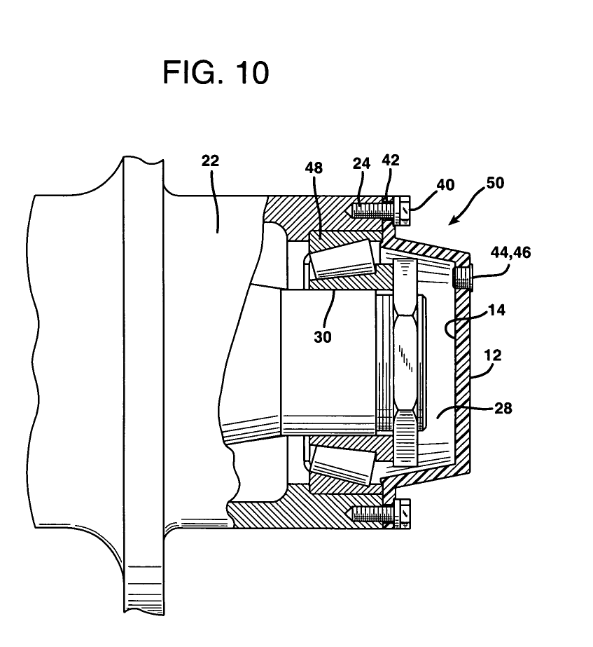

Referring to FIGS. 1-10, and in particular FIG. 1, the vehicle to be towed has a pair of wheels (not shown) that are driven by a drive axle 26. The axle 26 is removably mounted within an axle opening 30 in a drive axle hub or housing 22, the hub surrounding the axle opening 30. The wheels or tires are retained on brake drum assembly 16 by wheel retaining studs 18 therefore. The axle hub retaining nuts 40 on studs 24 retain the drive axle flange 32 and drive axle hub gasket 36 on the axle housing or hub 22. To remove the drive axle 26, the vehicle is raised to a height sufficient to maintain the wheels above the ground. Nuts 40 are removed from studs 24 to enable the removal of the axle 26 from axle housing 22. The axle hub 22 and bearings therein (48 in FIGS. 7 and 10) are now exposed and if towed in such a condition the oil drains out of housing 22 and road dust and dirt gets into the housing 22 and bearings.

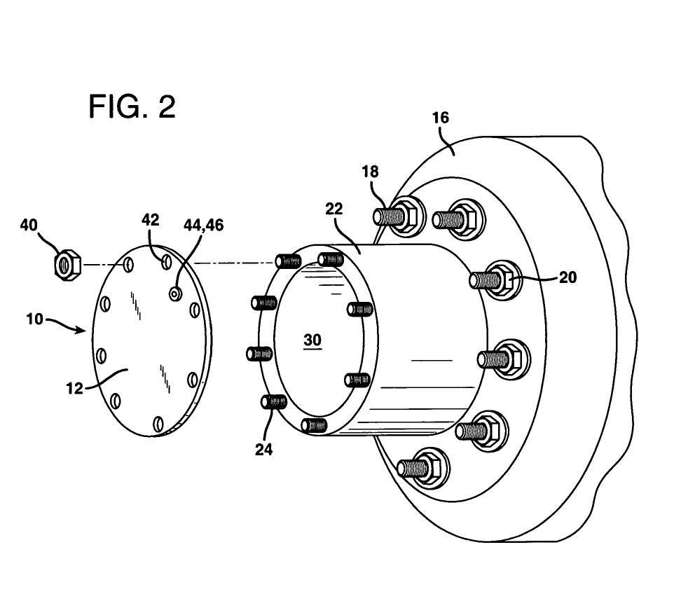

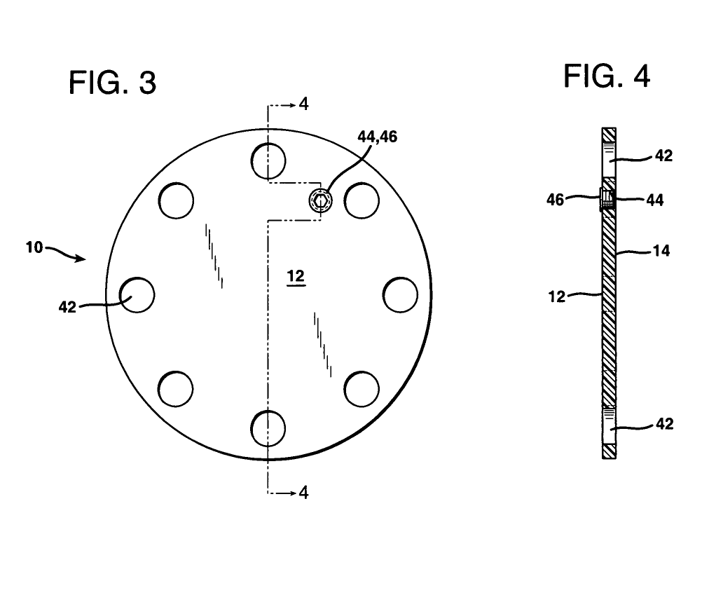

Referring to FIGS. 2-3, the hub cover 10 of this invention is designed for securement to the drive axle hub 22 after removal of a drive axle 26 therefrom. The axle cover 10 consists of a plate having an exterior surface 12 and an interior mounting surface 14. The plate is of a size sufficient to cover the hub 22 and the axle opening 30. Preferably the plate is cylindrical as depicted in the Figures, but any shape that covers the hub 22 and the axle opening 30 is contemplated. In the preferred embodiments, fifteen different size axle cover 10 models can be used to fit substantially every major truck and bus hub 22.

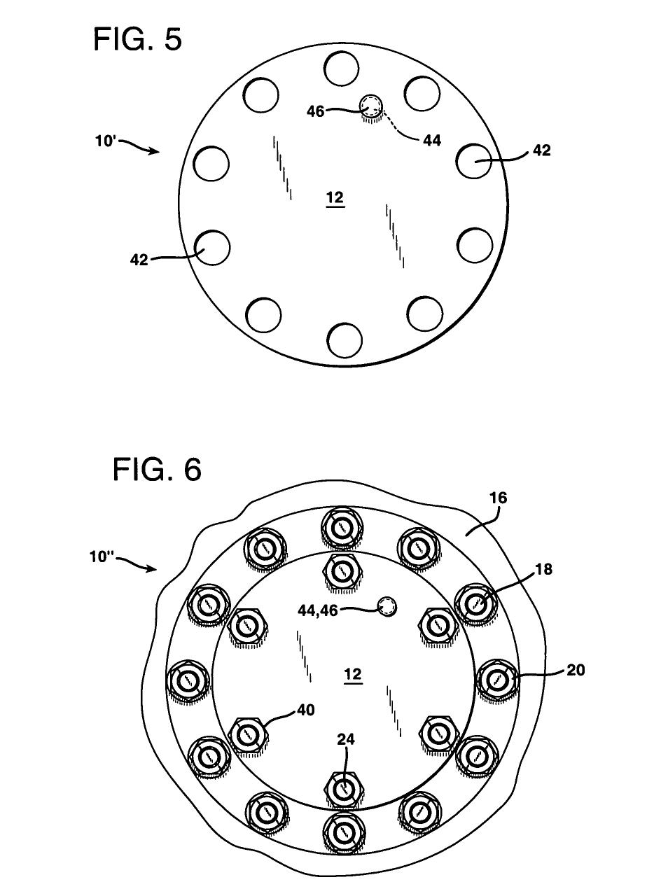

A mounting means is provided for mounting the hub cover 10 on the hub 22. Although numerous means are contemplated, the preferred means includes a plurality of mounting or stud holes 42 formed in the outer periphery of the plate. The mounting holes 42 are of a sufficient number and juxtaposition to mate with the retaining studs 24 on the hub 22 that were used to retain the axle drive flange 32 on the hub 22. It has been found that axle covers having eight holes (FIGS. 2-4, axle cover 10), ten holes (FIG. 5, axle cover 10′) and six holes (FIG. 6, axle cover 10″) are preferred, although axle covers with ten and twelve holes are also useful. The cover plate may have a pin hole to accommodate pin(s) that might extend from the hub.

An oil access means, e.g., an oil access hole 44 passing through the plate into the axle opening 30, is associated with the plate. A removable plug 46 is mounted in the oil access hole 44 and is removably accessible from the exterior surface 12. Thus before towing and at times during towing the plug 46 can be removed from the hole 44 and oil added to the axle opening 30.

After the cover 10 is placed on the retaining studs 24, passing through the mounting holes 42, the cover is secured to the hub 22 by drawing bolts 40 tightly onto studs 24. During this process the interior surface 14 and hub 22 form a sealing surface that surrounds the axle opening 30 to prevent leakage of oil from the opening.

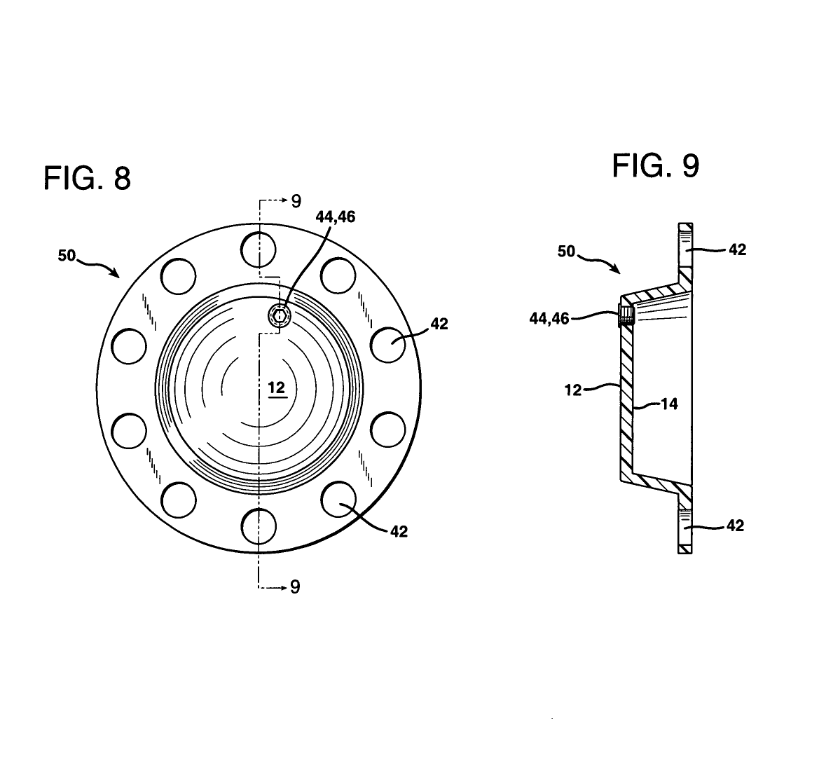

Preferably, the hub cover 10 is made of a molded or machined polymeric material, such as a high density polyethylene, with the interior mounting surface 14 being sufficiently soft to form the sealing surface with the hub such that a gasketless seal between the hub 22 and exterior surface can be maintained. Optionally, stamped aluminum may be used, particularly for a dished cover that is configured to accommodate a protruding axle tube. See, FIGS. 8-10

FIG. 7 is a partial cross-sectional view of the drive axle hub assembly having one of the embodiments of the axle hub cover of FIGS. 2-6 installed on hub 22 and showing bearing 48 in axle opening 30. The hub cover embodiment depicted is substantially planar on both sides of the cover 10. It is also contemplated, although not shown, that the sealing surface formed by the interior surface 14 and the hub can be a counter sunk surface to provide a greater amount of clearance for an axle tube housing that may protrude slightly from the face of the axle hub.

FIG. 8 is a plan view of a fourth embodiment of the axle hub cover of this invention wherein the cover 50 has a cap or dished configuration to accommodate an axle tube that extends beyond the hub end 22.

FIG. 9 is a cross-sectional view of the axle hub cover 50 depicted in FIG. 8 taken along line 9-9 thereof; and

FIG. 10 is a partial cross-sectional view of the drive axle hub assembly having the fourth embodiment of the axle hub cover 50 of FIGS. 8-9 installed thereon.

The axle cover can be any thickness that is adequate to maintain the oil in the housing 30. A typical range can be from about 0.125 inches to about 0.75 inches, with 0.500 inches being preferred. The diameter of the cover, number of stud holes on the plate, and stud hole sizes and positioning is dependant on the hub measurements, with different vehicle manufacturers using the same or different hubs.

The following is a summary of the preferred axle hub covers of this invention:

| | | Stud | Bolt Circle | |
|---|---|---|---|---|
| | Hub Diameter | Diameter | Diameter | Bolt Holes |
| Hub Brand | (inches) | (inches) | (inches) | (Number) |
| International | 6.25 | 9/16 | 5¼ | 8 |
| International | 6 11/16 | 11/16 | 5½ | 8 |
| International | 8⅜ | 13/16 | 7 | 8 |
| International | 8⅜ | ⅝ | 7 | 8 |
| Mack | 8½ | ⅝ | 7½ | 6 |
| Mack | 7⅜ | 9/16 | 6⅜ | 8 |
| Mack | 8½ | ⅝ | 7 | 8 |
| Mack | 6½ | 7/16 | 5¾ | 12 |
| Meritor/Rockwell | 8½ | ⅝ | 7 | 8 |
| Meritor/Rockwell | 8½ | ⅝ | 7 | 8 |
| Meritor/Rockwell | 8½ | ⅝ | | 8 |
| Meritor/Rockwell | 6¼ | 9/16 | 5⅜ | 8 |
| Meritor/Rockwell | 8½ | 9/16 | 7¼ | 10 |
| Meritor/Rockwell | 6¼ | ½ | 5¼ | 12 |
| Eaton | 9.0 | ⅝ | | 10 |
| Eaton | 7⅜ | ½ | 6½ | 12 |
| Combination | 8⅜ | ⅝ | 7 | 8 |

Typically, the axle hub covers are of a heavy duty design to provide years of use. The preferred high density polyethylene axle covers are equipped with an access hole for adding hub oil before towing, so the hub bearings will always have an oil supply during the tow. The polyethylene material also allows for a tight seal, eliminating the need for gaskets or washers. When the tow is completed, the hub cover is removed and reused.

Towing companies like to use them because they do not leak oil all over the road and have an oil access hole for adding oil to the hub. Their customers see that they are providing a professional, quality tow and are likely to give them repeat business. Fleet owners and maintenance managers like them because they insure against drive axle component damage while their bus or truck is being towed.

The foregoing constitutes a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure.

What is claimed is:

1. A hub cover for securement to a drive axle hub after removal of a drive axle therefrom, the hub surrounding an axle opening from which the drive axle has been removed and for retaining oil therein, the axle cover comprising:
a plate having an exterior surface and an interior mounting surface, the plate being of a size sufficient to cover the hub and the axle opening;
a mounting means for mounting the plate on the hub;
an oil access means associated with the plate for selectively adding oil to the axle opening and retaining the oil therein;
whereby when the plate is mounted to the hub the interior mounting surface and hub form a sealing surface that surrounds the axle opening to prevent leakage of oil from the opening.

2. A hub cover for securement to a drive axle hub after removal of a drive axle therefrom, the hub having a plurality of retaining studs mounted to the hub for mounting the drive axle thereto, the hub surrounding an axle opening from which the drive axle has been removed and for retaining oil therein, the axle cover comprising:
a plate having an exterior surface and an interior mounting surface, the plate being of sufficient diameter to cover the hub and the axle opening;
a plurality of mounting holes formed in the plate, the mounting holes of a sufficient number and juxtaposition to mate with the retaining studs;
an oil access hole passing through the plate into the axle opening;
a removable plug mounted in the oil access hole and removably accessible from the exterior surface;
whereby when the retaining studs pass through the mounting holes and the cover is secured to the hub, the interior surface and hub form a sealing surface that surrounds the axle opening to prevent leakage of oil from the opening.

3. A hub cover for securement to a drive axle hub after removal of a drive axle therefrom, the hub having a plurality of retaining studs axially mounted to the hub for mounting a flange of the drive axle thereto, the hub surrounding an axle opening from which the drive axle has been removed and for retaining oil therein, the axle cover comprising:
a substantially cylindrical plate having an exterior surface and an interior mounting surface, the plate being of sufficient diameter to cover the hub and the axle opening;
a plurality of mounting holes formed in the outer periphery of the plate, the mounting holes of a sufficient number and juxtaposition to mate with the retaining studs;
an oil access hole passing through the plate into the axle opening;
a removable plug mounted in the oil access hole and removably accessible from the exterior surface;
whereby when the retaining studs pass through the mounting holes and the cover is secured to the hub, the interior surface and hub form a sealing surface that surrounds the axle opening to prevent leakage of oil from the opening.

4. The hub cover of claim 1, wherein the plate is a polymeric plate and the interior mounting surface is sufficiently soft to form the sealing surface.

5. The hub cover of claim 1, wherein the plate is a polymeric plate and the interior mounting surface is sufficiently soft to form the sealing surface.

6. The hub cover of claim 1, wherein the interior surface is countersunk to mate with the hub to form the sealing surface.

7. A method of preparing a vehicle for towing, the vehicle having a pair of wheels driven by a drive axle, the drive axle removably mounted within an axle opening in a drive axle hub, the hub surrounding the axle opening, the method comprising:
a) raising the vehicle to a height sufficient to maintain the wheels above the ground;
b) removing the drive axle from the drive axle hub;
c) providing a hub cover for securement to the drive axle hub, the axle cover comprising:
i) a plate having an exterior surface and an interior mounting surface, the plate being of a size sufficient to cover the hub and the axle opening;
ii) a mounting means for mounting the plate on the hub;
iii) an oil access means associated with the plate for selectively adding oil to the axle opening and retaining the oil therein;
d) mounting the hub cover to the hub;
wherein the interior mounting surface and hub form a sealing surface that surrounds the axle opening to prevent leakage of oil from the opening.

8. The method of claim 6, wherein the plate is a polymeric plate and the interior mounting surface is sufficiently soft to form the sealing surface.

9. The method of claim 6, , wherein the plate is a high density polyethylene plate and the interior mounting surface is sufficiently soft to form the sealing surface.
